(19) United States
(12) Patent Application Publication
(10) Pub. No.: US 2024/0062546 A1
(43) Pub. Date: Feb. 22, 2024

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Yu Nabeto, Tokyo (JP); Haruna Watanabe, Tokyo (JP); Soma Shiraishi, Tokyo (JP)

(73) Assignee: NEC Corporation, Minato-ku, Tokyo (JP)

(21) Appl. No.: 18/270,666

(22) PCT Filed: Jan. 6, 2021
(86) PCT No.: PCT/JP2021/000216

§ 371 Date: Jun. 30, 2023

(51) Int. Cl. G06V 20/40; G11B 27/06; G11B 27/10; G11B 27/031

(52) U.S. Cl. CPC G06V 20/44; G06V 20/49; G11B 27/06; G11B 27/10; G11B 27/031

(57) ABSTRACT

In an information processing device, an acquisition means acquires a video material. An image recognition means detects an image of a target object from the video material. An event segment detection means detects each event segment in the video material by using a detection result of the image of the target object. A digest video is created by connecting event segments being detected in a time series.

### TECHNICAL FIELD

The present disclosure relates to processing of video data.

### BACKGROUND ART

Techniques for generating a video digest from video images have been proposed. Patent Document 1 discloses a highlight extraction device in which a learning data file is created from video images for training prepared in advance and video images for an important scene specified by a user, and the important scene is detected from target video images based on the learning data file.

### PRECEDING TECHNICAL REFERENCES

### Patent Document

Patent Document 1: Japanese Laid-open Patent Publication No. 2008-022103

### SUMMARY

### Problem to be Solved by the Invention

In a case of creating a digest video from a video material, it may be desired to create the digest video by collecting portions of the video in which a specific target object appears. For example, there are cases in which it is desired to create a digest video by gathering scenes in which a particular player of interest appears in a sports video, or in which it is desired to create a digest video by gathering a driving scene of a scenes of a particular car racing in a car race.

It is one object of the present disclosure to provide an information processing device capable of creating the digest video by focusing on a specific target object in the video material.

### Means for Solving the Problem

According to an example aspect of the present disclosure, there is provided an information processing device including:
an acquisition means configured to acquire a video material;
an image recognition means configured to detect an image of a target object from the video material; and
an event segment detection means configured to detect each event segment in the video material by using a detection result of the image of the target object.

According to another example aspect of the present disclosure, there is provided an information processing method including:
acquiring a video material;
detecting an image of a target object from the video material; and
detecting each event segment in the video material by using a detection result of the image of the target object.

According to still another example aspect of the present disclosure, there is provided a recording medium storing a program, the program causing a computer to perform a process including:

### Effect of the Invention

According to the present disclosure, it becomes possible to create a digest video by focusing on a specific target object in a video material.
acquiring a video material;
detecting an image of a target object from the video material; and
detecting each event segment in the video material by using a detection result of the image of the target object.

### BRIEF DESCRIPTION OF THE DRAWINGS

FIG. 1 illustrates a basic concept of a digest generation device.

FIG. 2A and FIG. 2B illustrate examples of a digest video and an event segment.

FIG. 3A and FIG. 3B are diagrams for explaining a generation method of training data for an event segment detection model.

FIG. 4 is a block diagrams illustrating a functional configuration of a training device of the event segment detection model.

FIG. 5 is a block diagram illustrating a hardware of the digest generation device.

FIG. 6 schematically illustrates a detection method of the event segment by the digest generation device of the first example embodiment.

FIG. 7 is a block diagram illustrating a functional configuration of the digest generation device of the first example embodiment.

FIG. 8 is a flowchart of a digest generation process by the digest generation device of the first example embodiment.

FIG. 9 schematically illustrates a detection method of the event segment by a digest generation device of a second example embodiment.

FIG. 10 is a block diagram illustrating a functional configuration of the digest generation device of the second example embodiment.

FIG. 11 is a flowchart of a digest generation process executed by the digest generation device of the second example embodiment.

FIG. 12 is a block diagram illustrating a functional configuration of an information processing device of a third example embodiment.

FIG. 13 is a flowchart of a process by the information processing device of the third example embodiment.

### EXAMPLE EMBODIMENTS

In the following, example embodiments will be described with reference to the accompanying drawings.

<Basic Concept of Digest Generation Device>

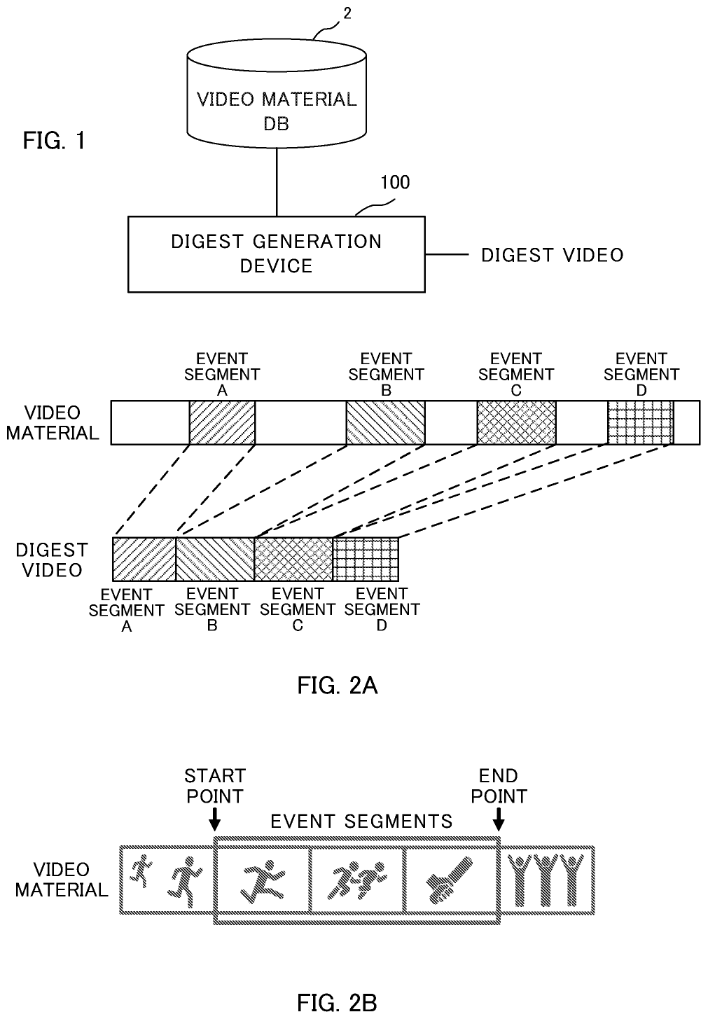

FIG. 1 illustrates a basic concept of a digest generation device. The digest generation device 100 is connected to a video material database (device, referred to as “DB”) 2. The video material DB 2 stores various video materials, that is, moving pictures. The video material may be, for instance, a video such as a television program broadcasted from a broadcasting station, or may be a video distributed by the Internet or the like. Note that the video material may or may not include audio.

The digest generation device 200 generates and outputs the digest video which uses a part of the video material stored in the video material DB 2. The digest video is a video in which scenes where some kind of event occurred in the video material are connected in a time series. As will be described later, the digest generation device 200 detects each event segment from the video material using an event segment detection model which has been trained by machine learning, and generates the digest video by connecting the event segments in the time series. The event segment detection model is a model for detecting each segment of the event from the video material, for instance, a model using a neural network can be used.

FIG. 2A illustrates an example of the digest video. In the example in FIG. 2A, the digest generation device 200 extracts event segments A to D included in the video material, and connects the extracted event segments in the time series to generate the digest video. Note that the event segments extracted from the video material may be repeatedly used in the digest video depending on contents thereof.

FIG. 2B illustrates an example of the event segment. The event segment is formed by a plurality of frame images corresponding to the scene in which some kind of event occurred in the video material. The event segment is defined by a start point and an end point. Note that instead of the end point, the event segment may be defined using a length of the event segment.

<Event Segment Detection Model>

Next, the event segment detection model will be described.

(Generation Method of the Training Data)

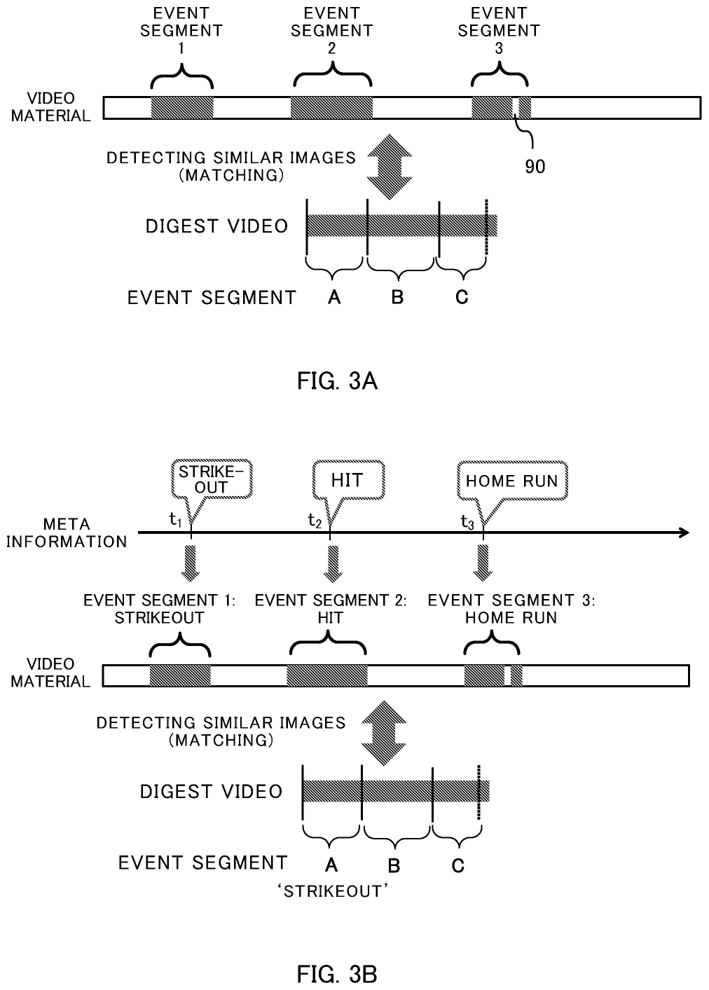

FIG. 3A is a diagram illustrating a generation method of the training data used for training the event segment detection model. First, an existing digest video is prepared. This digest video has already been created as containing appropriate content and includes a plurality of event segments A to C which are separated at appropriate points.

The training device of the event segment detection model performs matching between the video material and the digest video, detects each segment having a similar content as the event segment included in the digest video from the video material, and acquires time information of the start point and the end point of the event segment. Note that instead of the end point, a time range from the start point may be used. The time information indicates a timecode or a frame number in the video material. In the example in FIG. 3A, event segments 1 to 3 are detected in the video material corresponding to the event segments A to C in the digest video.

Note that even in a case where there is a segment with a slightly discrepant content between coincident segments where the video material and digest video are consistent in content, when a discrepant segment is less than a predetermined time range (that is, 1 second), the training device may consider the discrepant segment as one coincident segment together with a previous coincident segment and a subsequent coincident segment. In the example in FIG. 3A, in the event segment 3 of the video material, there is a disagreement segment 90 which does not match the event segment C in the digest video, but since a time range of the disagreement segment 90 is equal to or less than a predetermined value, the disagreement segment 90 is included in the event segment 3.

In a case where there is meta information which includes time and an event name (event class) of the event in the video material, the training device may use the meta information to assign tag information indicating the event name to each event segment. FIG. 3B illustrates an example of assigning tag information using the meta information. The meta information includes an event name “STRIKEOUT” of a time t₁, an event name “HIT” of a time t₂, and an event name “HOME RUN” of a time t₃. In this case, the training device assigns the tag information “STRIKEOUT” to the event segment 1 detected in the video material, the tag information “HIT” to the event segment 2, and the tag information “HOME RUN” to the event segment 3. The assigned tag information is used as a part of the correct answer data in the training data.

In the above-described example, the tag information is assigned to each event segment using the meta information including the event name, but instead, a human may assign the tag information to the digest video by visually inspecting each event forming the digest video. In this case, the training device may reflect the tag information assigned to the event segment of the digest video in the event segment of the video material corresponding to the event segment of the digest video based on a correspondence relationship obtained by matching the video material with the digest video. For instance, in the example in FIG. 3B, in a case where the tag information “STRIKEOUT” is assigned to an event segment A in the digest video, the training device may add the tag information “STRIKEOUT” to the event segment 1 corresponding to that event segment A in the video material.

(Configuration of the Training Device)

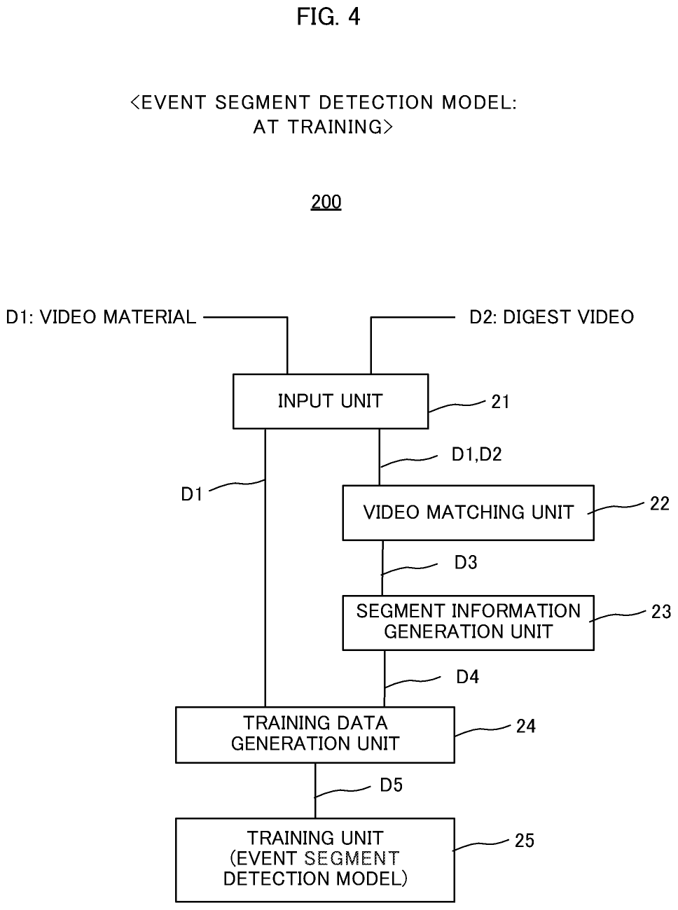

FIG. 4 is a block diagram illustrating a functional configuration of the training device 200 of the event segment detection model. The training device 200 includes an input unit 21, a video matching unit 22, a segment information generation unit 23, a training data generation unit 24, and a training unit 25.

A video material D1 and a digest video D2 are input to the input unit 21. The video material D1 corresponds to an original video of the training data. The input unit 21 outputs the video material D1 to the training data generation unit 24, and outputs the video material D1 and the digest video D2 to the video matching unit 22.

As illustrated in FIG. 3A, the video matching unit 22 performs the matching between the video material D1 and the digest video D2, generates coincident segment information D3 indicating a coincident segment in which the videos are matched in content, and outputs the coincident segment information D3 to the segment information generation unit 23.

The segment information generation unit 23 generates the segment information to be a series of scenes based on the matching segment information D3. In detail, in a case where a certain coincident segment is equal to or more than the predetermined time range, the segment information generation unit 23 determines that coincident segment as the event segment, and outputs segment information D4 of the event segment to the training data generation unit 24. Furthermore, in a case where a time range of the discrepancy segment between two consecutive coincident segments is equal to or less than a predetermined threshold value as described above, the segment information generation unit 23 determines the whole of the previous coincident segment, the subsequent coincident segment, and the discrepant segment as one event segment. The segment information D4 includes time information indicating the event segment in the video material D1. In detail, the time information indicating the event segment includes the times of the start point and the end point of the event segment or the time of the start point and the time range of the event segment.

The training data generation unit 24 generates the training data based on the video material D1 and the segment information D4. In detail, the training data generation unit 24 clips a portion corresponding to the event segment indicated by the segment information D4 from the video material D1 to make the training video. Specifically, the training data generation unit 24 clips a video from the video material D1 with respective certain ranges before and after the event segment. In this case, the training data generation unit 24 may randomly determine respective ranges to be applied before and after the event segment, or may apply ranges specified in advance. The ranges added before and after the event segment may be the same or may be different. In addition, the training data generation unit 24 sets the time information of the event segment indicated by the segment information D4 as the correct answer data. Accordingly, the training data generation unit 24 generates training data D5 which correspond to a set of the training video and the correct answer data for each event segment included in the video material D1, and outputs the training data D5 to the training unit 25.

The training unit 25 trains the event segment detection model using the training data D5 generated by the training data generation unit 24. In detail, the training unit 25 inputs the training video to the event segment detection model, compares an output of the event segment detection model with the correct answer data, and optimizes the event segment detection model based on an error. The training unit 25 trains the event segment detection model using a plurality of pieces of training data D5 generated from a plurality of video materials, and terminates the training when a predetermined termination condition is provided. The trained event unit detection model thus obtained can appropriately detect the event segment from the input video material, and output a detection result including time information indicating the segment, a score of an event likelihood, the tag information indicating the event name, and the like.

<Digest Generation Device>

Next, a digest generation device using the above-described trained event segment detection model will be described. In the present example embodiment, an image of a target object included in the video material is detected by image recognition, and a digest video is created by combining the image recognition with the event segment detection model.

### First Example Embodiment

First, a digest generation device according to a first example embodiment will be described.

(Hardware Configuration)

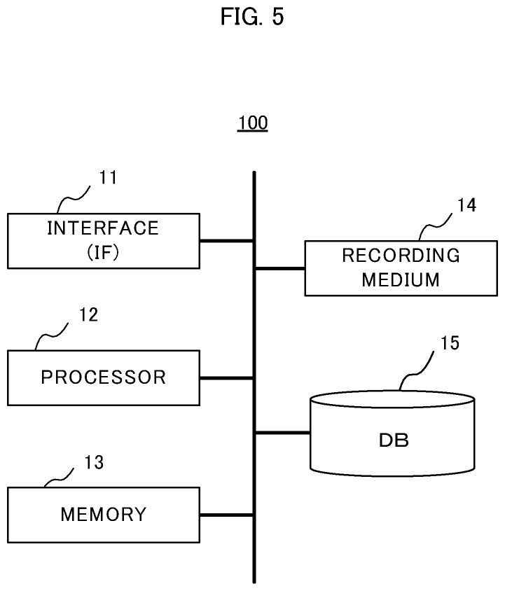

FIG. 5 is a block diagram illustrating a hardware configuration of the digest generation device 100 according to the first example embodiment. As illustrated, the digest generation device 100 includes an interface (IF) 11, a processor 12, a memory 13, a recording medium 14, and a database (DB) 15.

The IF 11 inputs and outputs data to and from an external device. In detail, the video material stored in the video material DB 2 is input to the digest generation device 100 through the IF 11. The digest video generated by the digest generation device 100 is output to the external device through the IF 11.

The processor 12 is a computer such as a CPU (Central Processing Unit, which controls the entire digest generation device 100 by executing programs prepared in advance. Specifically, the processor 12 executes a digest generation process which will be described later.

The memory 13 is formed by a ROM (Read Only Memory) and a RAM (Random Access Memory). The memory 13 is also used as a working memory during executions of various processes by the processor 12.

The recording medium 14 is a non-volatile and non-transitory recording medium such as a disk-shaped recording medium, a semiconductor memory, or the like, and is formed to be detachable to the digest generation device 100. The recording medium 14 records various programs to be executed by the processor 12. In a case where the digest generation device 100 performs various processes, the programs recorded on the recording medium 14 are loaded into the memory 13 and executed by the processor 12.

The database 15 temporarily stores the training video, existing digest videos, and the like which are input through the IF 11. The database 15 also stores information concerning the trained event segment detection model, information concerning the trained important scene detection model, a training data set used for training each model, and the like, which are used by the digest generation device 100. Note that the digest generation device 100 may include a keyboard, an input section such as a mouse, and a display section such as a liquid crystal display for a creator to instruct and input.

(Detection Method to Event Segment)

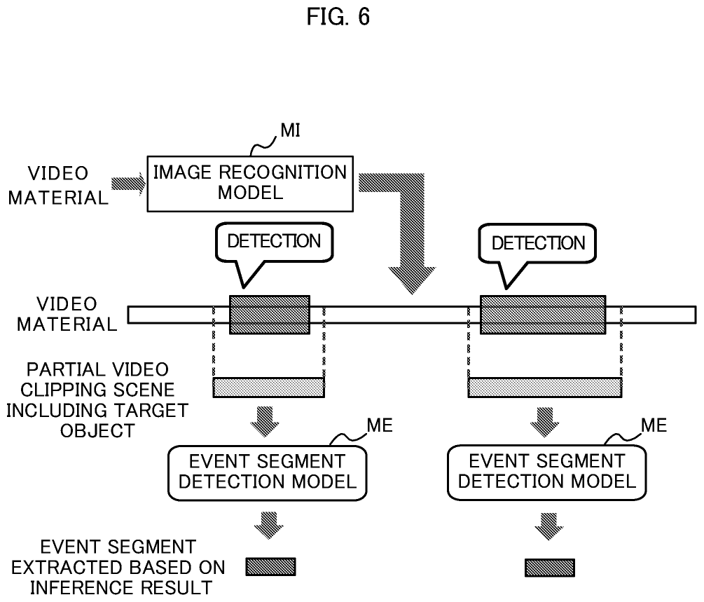

FIG. 6 schematically illustrates a detection method of the event segment by the digest generation device 100 according to the first example embodiment. In the first example embodiment, first, an image of a specific target object is detected from a video material, and a partial video including the detected image of the target object is input to the event segment detection model to detect the event segment.

Specifically, the video material is input into a trained image recognition model MI. For instance, the image recognition model MI is formed by an image recognition model using a neural network, and has been trained to recognize the particular target object included in the input image. The image recognition model MI detects a frame image including the target object from the video material, and detects time information indicating a position of the frame image or a frame image group in the video material. The digest generation device 100 clips the partial video including the detected image of the target object from the video material, and inputs the partial video to a trained event segment detection model ME. The event segment detection model ME detects the event segment from the input partial video.

(Functional Configuration)

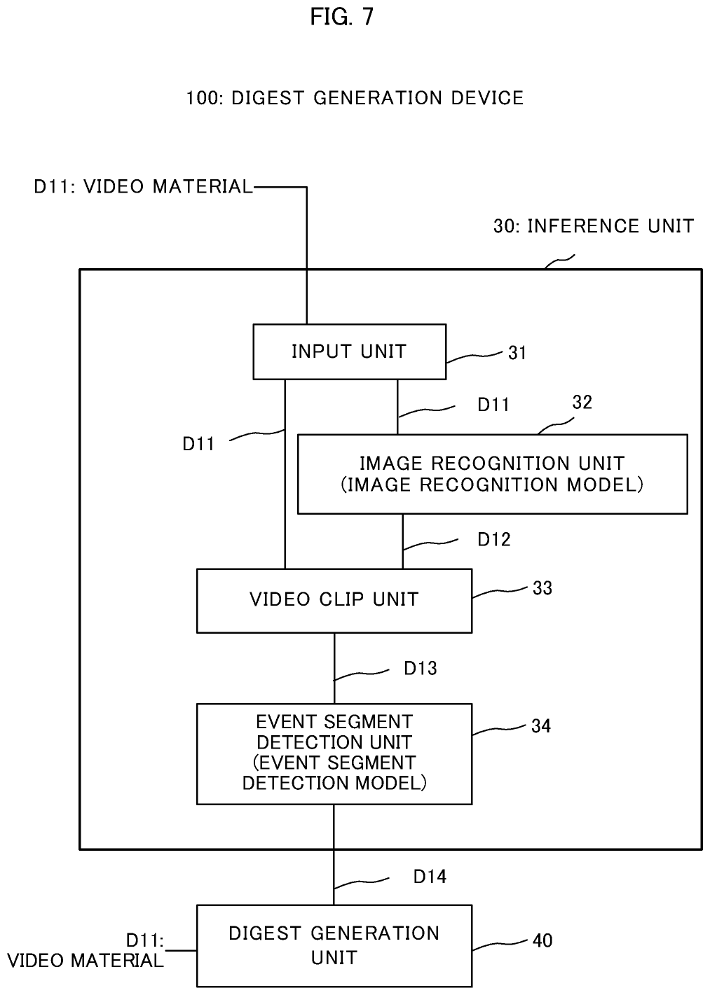

FIG. 7 is a block diagram illustrating a functional configuration of the digest generation device 100 according to the first example embodiment. The digest generation device 100 includes an inference unit 30 and a digest generation unit 40. The inference unit 30 includes an input unit 31, an image recognition unit 32, a video clip unit 33, and an event segment detection unit 34.

The video material D11 is input to the input unit 31. The input unit 31 outputs the video material D11 to an image recognition unit 32 and the video clip unit 33.

The image recognition unit 32 detects the target object from the video material D11 by using the trained image recognition model, and outputs target object image information D12 indicating the image which includes the target object to the video clip unit 33. For instance, the target object image information D12 includes time of the frame image including the detected target object, or time of the start point and the end point of the scene (frame image group) which includes the target object.

The video clip unit 33 clips a video of a portion including the target object from the video material D11, and outputs the clipped video as a partial video D13 to the event segment detection unit 34. As an example, the video clip unit 33 clips, as the partial video, a range where segments having a predetermined time range are respectively added before and after the frame image or the scene indicated by the target object image information D12. In this case, the time ranges to add before and after the image or the scene including the target object may be different.

The event segment detection unit 34 detects the event segment from the partial video D13 using the trained event segment detection model, and outputs a detection result D14 to the digest generation unit 40. The detection result D14 includes time information, scores of an event likelihood, the tag information, and the like for a plurality of event segments detected from the video material.

The video material D11 and the detection result D14 output by the inference unit 30 are input into the digest generation unit 40. The digest generation unit 40 clips each video of the event segment indicated by the detection result D14 from the video material D11, and generates the digest video by arranging the clipped videos in time series. In this manner, it is possible to generate the digest video by using the trained event segment detection model.

In the above-described configuration, the input unit 31 is an example of an acquisition means, the image recognition unit 32 is an example of an image recognition means, the video clip unit 33 is an example of an video clip means, the event segment detection unit 34 is an example of an event segment detection means, and the digest generation unit 40 is an example of a digest generation means.

(Digest Generation Process)

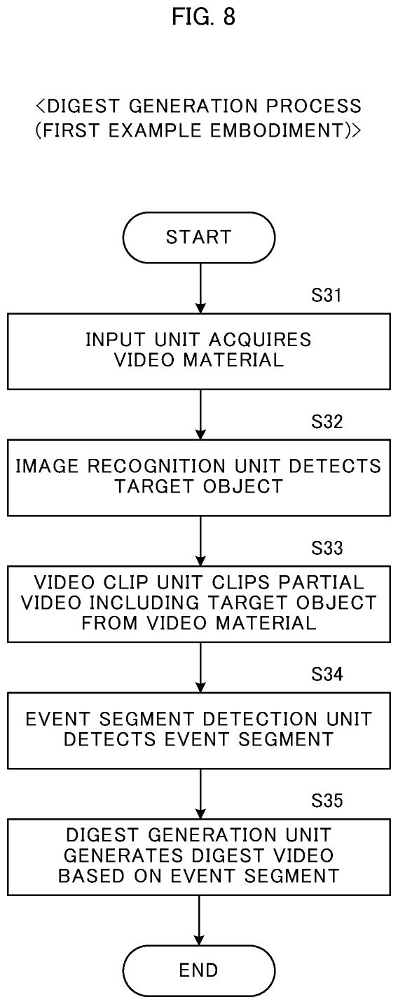

FIG. 8 is a flowchart of the digest generation process performed by the digest generation device 100 according to the first example embodiment. This digest generation process is realized by the processor 12 depicted in FIG. 5, which executes a program prepared in advance and operates as each of elements depicted in FIG. 7.

First, the input unit 31 acquires the video material D11 (step S31). The image recognition unit 32 detects the image or the scene including the target object from the video material D11, and outputs the target object image information D12 to the video clip unit 33 (step S32). Next, the video clip unit 33 clips out the partial video D13 corresponding to the frame image or the scene including the target object from the video material D11 based on the target object image information D12, and outputs the partial video D13 to the event segment detection unit 34 (step S33).

Next, the event segment detection unit 34 detects the event segment from the partial video D13 using the trained event segment detection model, and outputs the detection result D14 to the digest generation unit 40 (step S34). The digest generation unit 40 generates the digest video based on the video material D11 and the detection result D14 (step S35). After that, the process is terminated.

As described above, according to the digest generation device 100 of the first example embodiment, since the event segment is detected from a video portion including the target object in the video material, it is possible to generate the digest video in which the scene including the target object is collected.

### Modification

In the above-described example embodiment, the image recognition unit 32 performs the image recognition process for all frame images forming the video material; however, instead, the image recognition may be performed after thinning out the video material at a predetermined rate. In detail, a thinned video material in which a frame image is extracted every few frames or every few seconds from the video material may be generated, and an image recognition process may be performed on the thinned video material. Accordingly, it is possible to perform the image recognition process more efficiently and with higher speed.

### Second Example Embodiment

Next, a second example embodiment of the digest generation device will be described. Since a hardware configuration of a digest generation device 100x of the second example embodiment is the same as that of the first example embodiment illustrated in FIG. 5, the explanations thereof will be omitted.

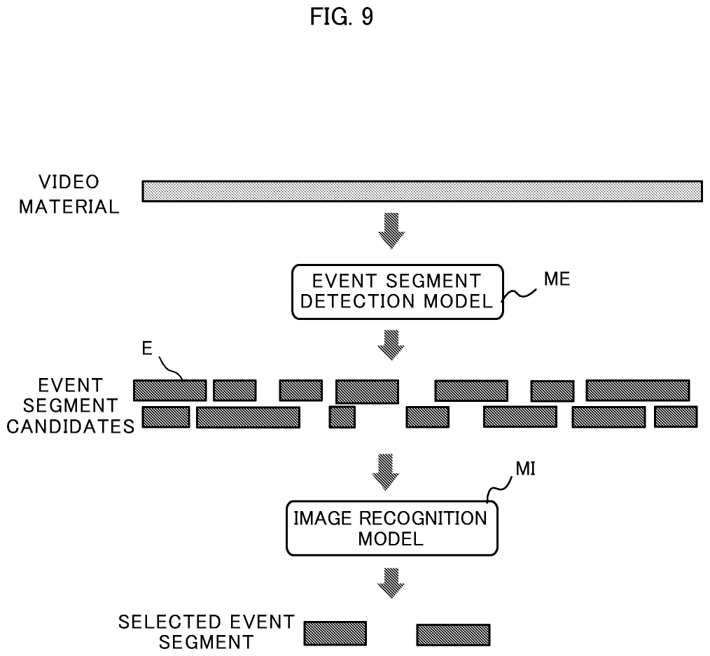

FIG. 9 schematically illustrates a detection method of the event segment by the digest generation device 100x according to the second example embodiment. In the second example embodiment, the digest generation device 100x first detects a plurality of event segment candidates E from the video material by using the trained event segment detection model ME. Next, the digest generation device 100x detects an image of the target object from each of the obtained event segment candidates E by using the image recognition model, and selects, as the event segment, the event segment candidates E in which each score indicating that a degree in which the image of the target object is included is higher than a predetermined threshold value.

Specifically, the video material is input into the trained event segment detection model ME. The event segment detection model ME detects the event segment candidates E from the video material. The digest generation device 100 inputs a plurality of detected event segment candidates E to the trained image recognition model MI. The image recognition model MI is trained to recognize the specific target object, and calculates a score (hereinafter, also referred to as a “target object score”) indicating a degree to which the target object is included in each of the input event segment candidates E, and selects, as the event segment, the event segment candidates E which each score is equal to or greater than a predetermined threshold value. Accordingly, among the event segment candidates E, each event segment candidate E having a high probability that the target object is included is selected as a final event segment. Note that in a case where a plurality of event segment candidates E are detected corresponding to the same time, the digest generation device 100x may select, as the event segment, one event segment candidate E having the highest target object score.

(Functional Configuration)

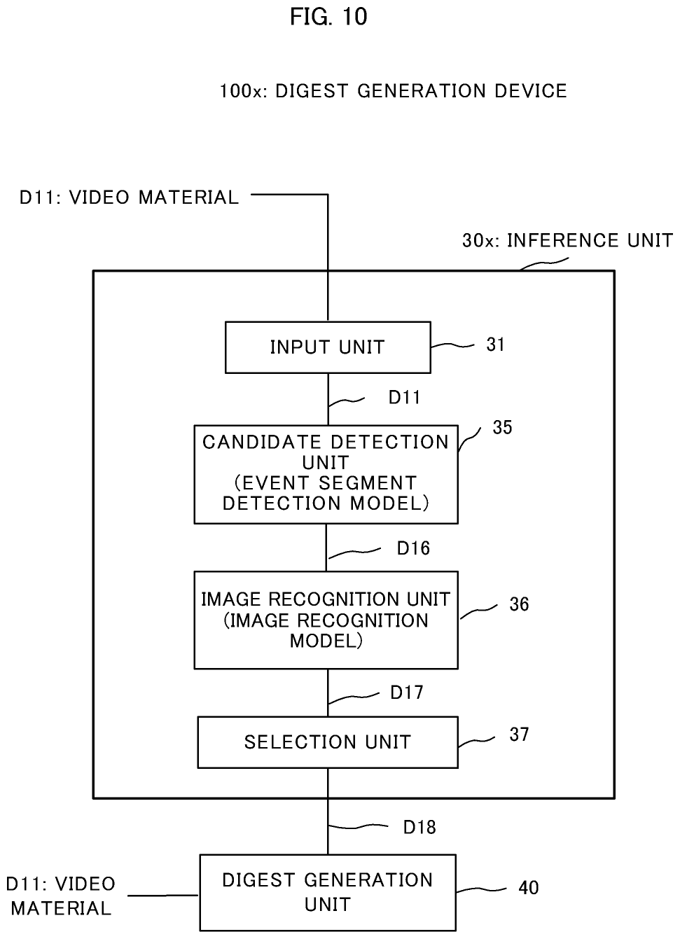

FIG. 10 is a block diagram illustrating a functional configuration of the digest generation device 100x according to the second example embodiment. The digest generation device 100x includes an inference unit 30x and a digest generation unit 40. The inference unit 30x includes the input unit 31, a candidate detection unit 35, an image recognition unit 36, and a selection unit 37.

The video material D11 is input to the input unit 31. The input unit 31 outputs the video material D11 to the candidate detection unit 35.

The candidate detection unit 35 detects the event segment candidate E from the video material D11 using the trained event segment detection model, and outputs event segment candidate information D16 to the image recognition unit 36. The image recognition unit 36 calculates respective target object degrees of the input event segment candidates E, and outputs the respective target object degrees to the selection unit 37 as score information D17.

The selection unit 37 selects the event segment based on the target object score calculated for each event segment candidate E. Specifically, the selection unit 37 selects, as the event segment, the event segment candidate E of which the target object score is equal to or greater than the predetermined threshold value, and outputs a detection result D18 to the digest generation unit 40. The digest generation unit 40 is the same as the first example embodiment, and generates the digest video using the video material D11 and the detection result D18.

In the above-described configuration, the input unit 31 is an example of an acquisition means, the image recognition unit 36 is an example of an image recognition means, the candidate detection unit 35 and the selection unit 37 correspond to an example of an event segment detection means, and the digest generation unit 40 is an example of a digest generation means.

(Digest Generation Process)

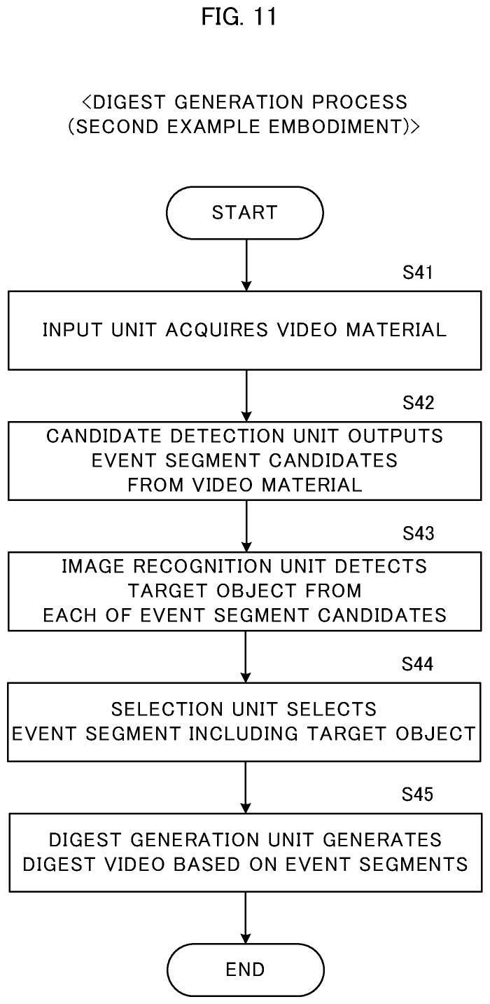

FIG. 11 is a flowchart of the digest generation process which is executed by the digest generation device 100x according to the second example embodiment. This digest generation process is realized by the processor 12 depicted in FIG. 5, which executes a program prepared in advance and operates as each of elements depicted in FIG. 10.

First, the input unit 31 acquires the video material D11 (step S41). The candidate detection unit 35 detects each event segment candidate E from the video material using the trained event segment detection model, and outputs the event segment candidate information D16 to the image recognition unit 36 (step S42). Next, the image recognition unit 36 calculates the target object score for each event segment candidate E, and outputs the score information D17 to the selection unit 37 (step S43).

The selection unit 37 selects each event segment candidate E of which the target object score is equal to or greater than the predetermined threshold value as the event segment, and outputs the detection result D18 to the digest generation unit 40 (step S44). The digest generation unit 40 generates the digest video based on the video material D11 and the detection result D18 (step S45). After that, the digest generation process is terminated.

As described above, according to the digest generation device 100x of the second example embodiment, it is possible to select an appropriate event segment candidate based on the target object score from a plurality of event segment candidates detected from the video material and to create the digest video. Therefore, it is possible to create the digest video in which the scenes including the target object are collected.

### Third Example Embodiment

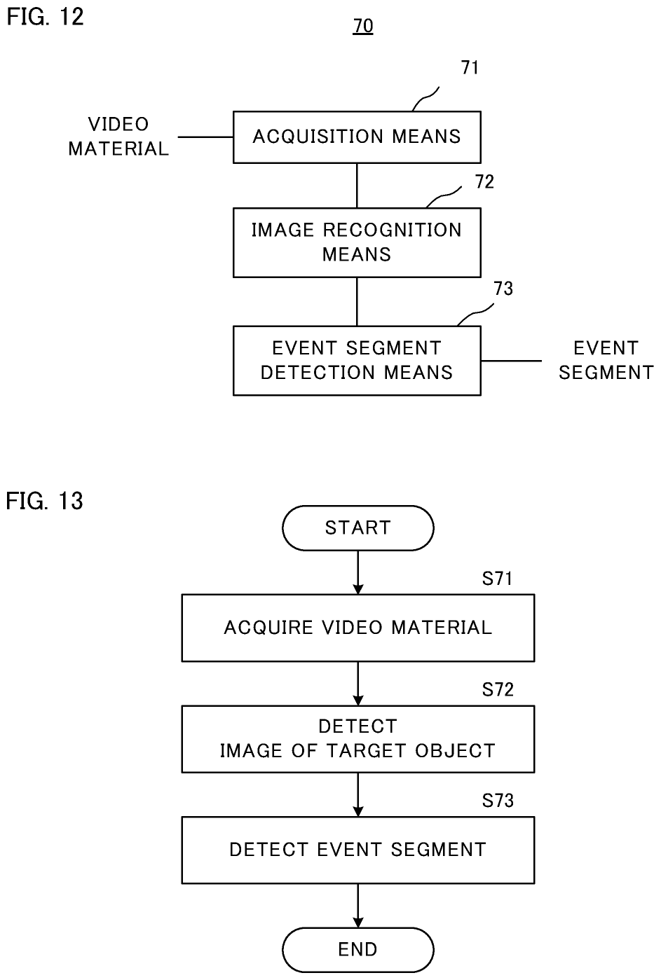

Next, an information processing device according to a third example embodiment will be described. FIG. 12 is a block diagram illustrating a functional configuration of an information processing device according to the third example embodiment. As illustrated, an information processing device 70 includes an acquisition means 71, an image recognition means 72, and an event segment detection means 73.

FIG. 13 is a flowchart of a process performed by the information processing device 70. The acquisition means 71 acquires the video material (step S71). The image recognition means 72 detects the image of the target object from the video material (step S72). The event segment detection means 73 detects the event segment in the video material using the detection result of the image of the target object (step S73).

A part or all of the example embodiments described above may also be described as the following supplementary notes, but not limited thereto.

(Supplementary Note 1)

An information processing device comprising:
an acquisition means configured to acquire a video material;
an image recognition means configured to detect an image of a target object from the video material; and
an event segment detection means configured to detect each event segment in the video material by using a detection result of the image of the target object.

(Supplementary Note 2)

The information processing device according to supplementary note 1, further comprising a video clip means configured to generate a partial video by clipping a portion including the image of the target object from the video material,
wherein the event segment detection means detects the event segment from the partial video.

(Supplementary Note 3)

The information processing device according to supplementary note 2, wherein the video clip means clips, as the partial video, a range in which predetermined time ranges are added respectively before and after the image of the target object.

(Supplementary Note 4)

The information processing device according to supplementary note 1, wherein the event segment detection means detects a plurality of event segment candidates from the video material, and selects an event segment from the plurality of event segment candidates based on the detection result of the image of the target object.

(Supplementary Note 5)

The information processing device according to supplementary note 4, wherein
the image recognition means calculates each score indicating a degree to which the target object is included in the plurality of event segment candidates, and
the event segment detection means selects, as the event segment, each event segment candidate of which the score is equal to or greater than a predetermined value.

(Supplementary Note 6)

The information processing device according to supplementary note 5, wherein the event segment detection means selects, as the event segment, each event segment candidate having the highest score in a case of detecting a plurality of event segment candidates corresponding the same time.

(Supplementary Note 7)

The information processing device according to any one of supplementary notes 1 to 6, further comprising a digest generation means configured to generate a digest video by connecting videos of event segments in a time series based on the event segments detected by the event segment detection means.

(Supplementary Note 8)

An information processing method comprising:
acquiring a video material;
detecting an image of a target object from the video material; and
detecting each event segment in the video material by using a detection result of the image of the target object.

(Supplementary Note 9)

A recording medium storing a program, the program causing a computer to perform a process comprising:
acquiring a video material;
detecting an image of a target object from the video material; and
detecting each event segment in the video material by using a detection result of the image of the target object.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

12 Processor
21, 31 Input unit
22 Video matching unit
23 Segment information generation unit
24 Training data generation unit
25 Training unit
30, 30x Inference unit
32, 36 Image recognition unit
33 Video clip unit
34 Event segment detection unit
35 Candidate detection unit
37 Selection unit
40 Digest generation unit
100, 100x Digest generation device
200 Training device

What is claimed is:

1. An information processing device comprising:
a memory storing instructions; and
one or more processors configured to execute the instructions to:
acquire a video material;
detect an image of a target object from the video material; and
detect each event segment in the video material by using a detection result of the image of the target object.

2. The information processing device according to claim 1, wherein the processor is further configured to generate a partial video by clipping a portion including the image of the target object from the video material,
wherein the processor detects the event segment from the partial video.

3. The information processing device according to claim 2, wherein the processor clips, as the partial video, a range in which predetermined time ranges are added respectively before and after the image of the target object.

4. The information processing device according to claim 1, wherein the processor detects a plurality of event segment candidates from the video material, and selects an event segment from the plurality of event segment candidates based on the detection result of the image of the target object.

5. The information processing device according to claim 4, wherein
the processor calculates each score indicating a degree to which the target object is included in the plurality of event segment candidates, and
the processor selects, as the event segment, each event segment candidate of which the score is equal to or greater than a predetermined value.

6. The information processing device according to claim 5, wherein the processor selects, as the event segment, each event segment candidate having the highest score in a case of detecting a plurality of event segment candidates corresponding the same time.

7. The information processing device according to claim 1, wherein the processor is further configured to generate a digest video by connecting videos of event segments in a time series based on the event segments being detected.

8. An information processing method comprising:
acquiring a video material;
detecting an image of a target object from the video material; and
detecting each event segment in the video material by using a detection result of the image of the target object.

9. A non-transitory computer-readable recording medium storing a program, the program causing a computer to perform a process comprising:
acquiring a video material;
detecting an image of a target object from the video material; and
detecting each event segment in the video material by using a detection result of the image of the target object.
